(19) United States
(12) Patent Application Publication
(10) Pub. No.: US 2025/0199781 A1
(43) Pub. Date: Jun. 19, 2025

(54) SYSTEMS AND METHODS FOR AUTOMATED SOFTWARE PROCESS DEPENDENCY ESTIMATION

(71) Applicant: HSBC GLOBAL SERVICES (UK) LIMITED, London (GB)

(72) Inventor: Charles RUSSELL, Tonbridge (GB)

(21) Appl. No.: 19/006,994

(22) Filed: Dec. 31, 2024

(51) Int. Cl. G06F 8/41

(52) U.S. Cl. CPC G06F 8/433

(57) ABSTRACT

A system for automated software process dependency estimation is proposed. A specialized computer system is configured to execute a system dependency estimation computing process that automatically conducts code checks against computing system elements in a codebase. The system is operated by a user, through, for example, a user interface page. The system conducts a scan against data elements and generates an intermediate data object having individual touchpoint record data objects based on search anchor points identified during the scan. On the user inface, a user classifies each estimated touchpoint and identifies a resolution of a potential dependency, updating the intermediate data object. The updated intermediate data object can be used as a feedback dataset to improve automated labelling. Upon completion of the intermediate data object, a downstream data process may be triggered to proceed.

### FIELD

The present application relates to computer architectures adapted for error control relating to software process dependencies, and more specifically, to systems and methods for automated software process dependency estimation.

### Introduction

Enterprise code bases and software development, especially for large organizations incorporate code bases from acquisitions, legacy code, among others, and the codebase and process functions become a vast and complex computing asset to track, from an inventory perspective.

The code functionality and processes can be interdependent, and whenever the development team are tasked with making systematic changes that require a review of the code base, a long and complex analysis task is performed to help ensure operational stability and continuity.

Firstly, a fix script needs to be run manually in order to define the elements of the systems that may be affected. This fix script provides a text-based output that contains both the script logs, but also all the system logs that are generated at the same time as the fix script run. The text has to be exported manually and pasted into Excel. Once done, the dataset has to be filtered to show only those logs that arise from the fix script. Then, each line needs to be moved text to columns to separate the information from the URL assigned to it. Once that is done, the URLs can be copied manually and pasted into a browser to allow for analysis of the record. New columns then need to be added to the spreadsheet to show which elements have been reviewed, which are relevant to the story or not, and notes related to the investigation. Once complete, the spreadsheet is uploaded to the development story for reference and development guidance.

A significant challenge is that dependencies are not always well tracked or easily identified, and if missed, during execution of the program functions, the program functions may exhibit strange behaviour, throw exceptions, or simply crash. This is especially problematic for enterprise code bases, where there are many critical software processes operating at any given time, while also having a large legacy codebase where it is difficult for any one software architect to understand all of the specific components at the dependency level.

### SUMMARY

A system for automated software process dependency estimation is proposed. A specialized computer system is configured to execute a system dependency estimation computing process that automatically conducts code checks against computing system elements in a codebase.

The system is operated by a user, through, for example, a user interface page. On this UI page, a user with access can enter a line of text with which to analyse the system, reducing or eliminating other manual steps. The system outputs a system dependency record data object that is created which holds the information selected on the request page, along with the user details of the person who ran it and the type of request (Options are Data level, Field level and Table level requests). Attached to each systems dependency record data object, is a list of system touchpoint record data objects, which are created when the parent system dependency record is created as an intermediate data object. The systems dependency record data objects can be referred to directly in the saved software developer story fields to aid swift review and action by the developers. As this has been created as a custom application, it can be extracted and used in other instances of a development ticket tracking system, if required. The output systems dependency record data objects can be used for re-training a machine learning engine for improving automatic state classifications.

The touchpoint record data objects hold information about all the areas where a possible match has been found against the inputted text. The system touchpoint record data object can contain an accessible link to the target record for easy access and investigation, plus fields for the State (New, Complete) Investigation Result (Dependency, No Action Required, Further Investigation Required, No valid Dependency). There is also a large text input field for comments which can further include commentary or explanations regarding an investigation result. On the user interface, there may also be the ability to visually render linked System touchpoints where a touchpoint element may have been called from another element in the system.

Elements in the system that can be reviewed for dependencies in the application can include: Reference Columns, List Column, Database Views, Reports, Logical Business Rules, Client Scripts, Catalogue Client Scripts, Widgets, Scheduled Script Execution, Script Actions, Workflows, Transform Scripts, Field Maps, UI Actions, UI Pages, Column Calculated Values/Reference Qualifiers, Dictionary Overrides, Processors, Variables. Scripts can include, plus following linked elements: Logical/Business Rules, Client Scripts, Catalogue Client Scripts, Widgets, Scheduled Script Execution, Script Action, Workflow, Transform Scripts, Field Maps, UI Actions, UI Pages, Column Calculated Values/Reference Qualifiers, Dictionary Overrides, Processors, Variables, among others.

The approach is provided as a computer implemented system for automated software process dependency estimation, comprising one or more computing processors that operate in conjunction with computer memory and data storage.

The one or more computing processors are configured to receive a dependency search query data message indicative of a search string for an identified search scope for a set of data elements, generate, from the dependency search query data message, a plurality of sub-search scripts, each corresponding to every data element type in the set of data elements, execute the plurality of sub-search scripts against the set of data elements to generate an intermediate touchpoint data object having one or more rows representing system touchpoint records each corresponding to an anchor position data object for each match to the sub-search scripts found in the set of data elements, augment the system touchpoint records of the intermediate touchpoint data object with data snippets using a crawler process configured to extract information proximate to coordinates of the anchor position data object, receive one or more user interface visual element interaction data objects to update a state associated with each of the system touchpoint records; and trigger a downstream computational process to execute when the system touchpoint records of the intermediate touchpoint data object have transitioned into a completed state.

The intermediate touchpoint data object, once completed, can be converted into a snapshot data object and used to update trainable parameters of the trainable machine learning backend, which is configured for automatic state identification based on classification labels that are used to pre-populate the state associated with each of the system touchpoint records using the data snippets. The pre-populating of the state the associated with each of the system touchpoint records using the data snippets is conducted during the augmenting of the intermediate touchpoint data object, using machine learning approaches to reduce an overall burden by establishing a training feedback loop using completed dependency identifications and/or resolutions.

The system touchpoint records, once generated, can be assigned for resolution by individual system owner user identifiers as identified by an active directory repository managing user account relationships with the data element from which the corresponding system touchpoint record is generated from.

The downstream computational process that is executed can include a systems update or code modification corresponding to the dependency search query data message, and the systems update or code modification is executed against all data elements identified in the system touchpoint records. In another variation, the systems update or code modification is executed against only against all data elements identified in the system touchpoint records having a state indicative of a valid dependency.

Following the systems update or the code modification all data elements identified in the system touchpoint records having a state indicative of a valid dependency are associated with a system mobility monitoring process, such as a monitoring daemon that that tracks overall system stability after a migration or a modification. The system mobility monitoring process is configured to automatically trigger a rollback of the systems update or the code modification upon determining that a computing process or a computing module failure has occurred at any of the data elements identified in the system touchpoint records. This is useful in the event that the system stability has significantly decreased, providing a safety backstop to the system.

The system can be implemented a special purpose computing appliance residing in a data center and coupled by a message bus to one or more codebase repositories, receiving as an input the dependency search query data message from the message bus, and generating the trigger signal to trigger the downstream computational process as an output on the message bus. The special purpose computing appliance is coupled with machine interpretable instructions which when executed by a processor or one or more processors of the special purpose computing appliance, perform a method as described in various herein.

The foregoing has outlined the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is a block schematic diagram of a specialized computer system that is configured to execute a system dependency estimation computing process that automatically conducts code checks against computing system elements in a codebase, according to some embodiments.

FIG. 2 shows an example UI page including an interactive query entry input data object, according to some embodiments.

FIG. 3 is an example UI page including an example intermediate data object showing a set of touchpoint record data objects as visually represented, according to some embodiments.

FIG. 4 is an example UI page showing an example code snippet that was first identified as having a match therein, and then an anchor point is generated, according to some embodiments.

FIG. 5A is an example UI page including an example intermediate data object showing a set of touchpoint record data objects as visually represented alongside proximate snippets and investigation links, according to some embodiments.

FIG. 5B is an example UI page where a reviewer/investigator user can modify a state using a visual interactive interface element, according to some embodiments.

FIG. 6 is an example UI page where user tasks are identified based on a project view, according to some embodiments.

FIG. 7 is an example UI page user tasks are identified based on a user identifier view, according to some embodiments.

FIG. 8 is a process flow diagram showing steps of an example computing method for automated software process dependency estimation, according to some embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

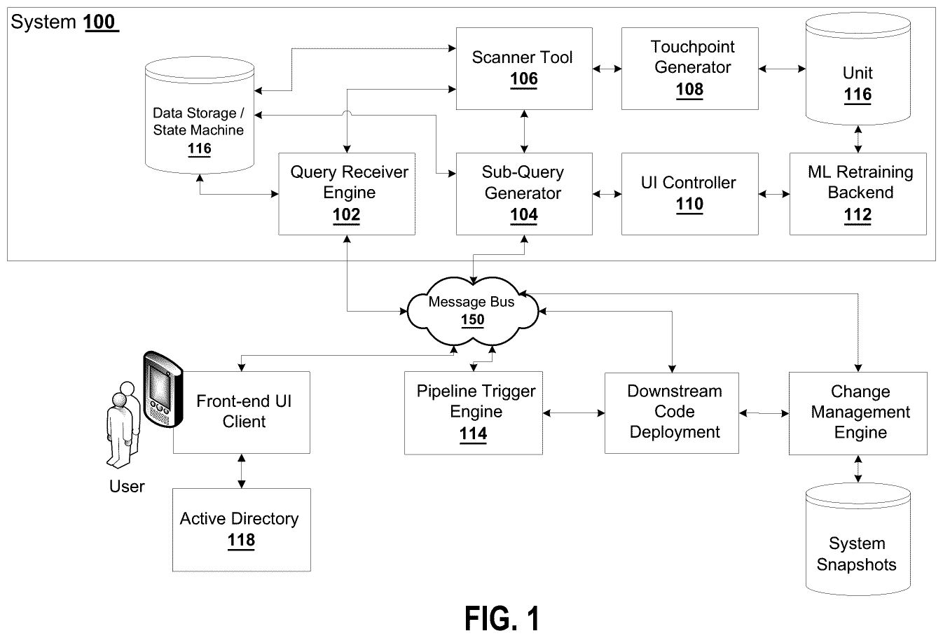

A system for automated software process dependency estimation is proposed. FIG. 1 is a block schematic diagram of a specialized computer system that is configured to execute a system dependency estimation computing process that automatically conducts code checks against computing system elements in a codebase, according to some embodiments. The system 100 can operate as a special purpose machine operating in an enterprise data warehouse or a data center configured to receiving dependency query strings across a coupled message bus 150, and outputting scan results to identify potential code touchpoints and exposing them on a configured user interface. The system 100 includes a query receiver engine 102, a sub-query generator 104, a scanner tool 106, a candidate touchpoint generator engine 108, a user interface controller 110, a trainable machine learning backend 112, a pipeline trigger engine 114, and a state machine 116.

A query task is received from the query receiver engine 102 including a target string or operator combination including string portions to be used to initiate the scan, which can include structured search strings or freetext search strings, and the sub-query generator 104 is configured to translate the structured search strings or freetext search strings into executable search scripts for different types of searches that are made available in the system 100. The types of searches and target data elements can be provided alongside the string portions in a query request data object, controlling the scope of the search. The sub-query generator 104 may be configured to generate different types of script processes and these can be generated by customizing or tweaking baseline template script processes that are maintained in a coupled library.

An example script is shown in the code snippet below:

Code Snippet 1:

| Script | [symbol] [symbol] [symbol] [symbol] [symbol] [symbol] [symbol] [symbol] [symbol] [symbol] [symbol] [symbol] | | | |
|---|---|---|---|---|
| 1 | (function executeRule(current, previous /*null when async*/ ) { | | | |
| 2 | \| | //add max 3 layers in SI | | |
| 3 | \| | //Set Global variables | | |
| 4 | \| | | | |
| 5 | \| | var sysDep = current.sys_id; | | |
| 6 | \| | var relatedParent = ‘ ’; | | |
| 7 | \| | var touchpointType = ‘ ’; | | |
| 8 | \| | var touchpointName = ‘ ’; | | |
| 9 | \| | var additionalInfo = ‘ ’; | | |
| 10 | \| | var table = ‘ ’; | | |
| 11 | \| | | | |
| 12 | \| | funDependencyChecks( ); | | |
| 13 | \| | | | |
| 14 | \| | function runDependencyChecks( ) { | | |
| 15 | \| | \| | | |
| 16 | \| | \| | var systemCheckType = current.u_element_type; | |
| 17 | \| | \| | var name = ‘ ’; | |
| 18 | \| | \| | | |
| 19 | \| | \| | If (systemCheckType == ‘ [symbol] ’) { //Role | |
| 20 | \| | \| | \| | |
| 21 | \| | \| | \| | name = current.u_role.name; |
| 22 | \| | \| | \| | |
| 23 | \| | \| | \| | checkAccessControl(name); |
| 24 | \| | \| | \| | checkAccessControlRole(name); |
| 25 | \| | \| | \| | checkApplicationMenu(name); |
| 26 | \| | \| | \| | checkAssociatedRoles(name); |
| 27 | \| | \| | \| | checkBusinessRule(name); |
| 28 | \| | \| | \| | checkCatalogueClientScripts(name); |
| 29 | \| | \| | \| | checkClientScript(name); |
| 30 | \| | \| | \| | checkContextMenu(name); |
| 31 | \| | \| | \| | checkDynamicContent(name); |
| 32 | \| | \| | \| | checkFixScript(name); |
| 33 | \| | \| | \| | checkInboundEmailActions(name); |
| 34 | \| | \| | \| | checkMenuItem(name); |
| 35 | \| | \| | \| | checkModule(name); |
| 36 | \| | \| | \| | checkNavigationHandler(name); |
| 37 | \| | \| | \| | checkProcessors(name); |
| 38 | \| | \| | \| | checkPushNotificationActions(name); |
| 39 | \| | \| | \| | checkRelationship(name); |
| 40 | \| | \| | \| | checkRole(name); |
| 41 | \| | \| | \| | checkRoleDictionaryEntry(name); |
| 42 | \| | \| | \| | checkRoleGroups(name); |
| 43 | \| | \| | \| | checkScriptAction(name); |
| 44 | \| | \| | \| | checkScriptedMedService(name); |
| 45 | \| | \| | \| | checkSysWidget(name); |
| 46 | \| | \| | \| | checkUIAction(name); |
| 47 | \| | \| | \| | checkUIActionMobile(name); |
| 48 | \| | \| | \| | checkUIMacro(name); |
| 49 | \| | \| | \| | checkUIPage(name); |
| 50 | \| | \| | \| | checkUIPolicy(name); |
| 51 | \| | \| | \| | checkUIScript(name); |
| 52 | \| | \| | \| | checkViewRule(name); |
| 53 | \| | \| | \| | checkWidget(name); |

[symbol]

indicates data missing or illegible when filed

The scanner tool 106 is a data process that is configured to execute the search scripts against one or more coupled repositories, the search scripts selected from a generated set based on data element type. In some embodiments, the search scripts are run against a snapshot data object generated as an intermediate object for improved search speed, at the cost of storage requirements, which allows a single script for each type to be executed once as opposed to individual access. In an alternate embodiment, the search scripts access data elements, are executed, and are configured to generate estimated touchpoint data records that are gathered together into an intermediate data object representing the scan results having specific anchor points identified within the data elements that are a match to a logical condition of the data element specific sub-query. The candidate touchpoint generator engine 108 augments the intermediate data object by automatically executing a process that gathers related data field information proximate to the specific anchor points and automatically generating a snippet along with touchpoint features, such as a type of match, whether the match is located in code, in a code comment block, in an in-line comment, in an argument/function call, in a library name, in a header, among others.

Once the intermediate data object is augmented with this information, the scan results are ready for presentation to one or more users through a user interface. The scan results can be interacted with through the user interface as provided by the user interface controller 110, assigning tasks to various user identifiers in an active directory repository 118. For example, flagged estimated dependencies are identified for insertion into a review pipeline buffer controlled by user interface controller 110, where review states are managed automatically. Potential code touchpoints are converted into anchor data objects having coordinate information for investigation, and the user interface is configured to include snippets and provide an investigation pane provided by the user interface controller 110, for dependency validation and potential flag for resolution through user interface updates that ultimately are used to modify state representations of the records or individual fields associated with the records through state machine 116.

When all of the review states have shifted into a reviewed and approved state, the state machine 116 is configured for generating a clearance signal by the pipeline trigger engine 114 that can be electronically communicated to a downstream computational update manager for automatically implementing a systems update. The system can, for example, couple with a version control system that is used to control deployments and code commits as atomic code operations to update a codebase. By first automatically identifying potential dependencies and managing a state-based clearance process, code deployments and code commits that update code that may impact dependencies can be safely managed through a gated process. After the review is complete and dependencies are resolved, a completed dataset may be automatically collated for updating a labelling engine's trainable parameters using trainable machine learning backend 112, reducing the review burden for downstream flagged dependencies.

It is not always clear whether a dependency is a valid dependency, or a false dependency, especially in respect of legacy software code. For example, in legacy software code, outdated coding practices may lead to confusion, and automated systems struggle with identifying a missed valid dependency. If a valid dependency is missed, there could be a major systems failure during a migration or update effort, yielding serious system stability ramifications. In legacy software code and other code, developers may enter text into different fields, such as metadata tags, into in-line comments or block comments.

As every developer or era of development may have a different style, this variability can become a major problem as the codebase increases in size. For example, there can also be variability in coding conventions such as indentations, comments, declarations, statements, naming conventions, which has a deleterious impact on maintenance, especially as code developers pass on the responsibility to other developers as they change positions or change groups. The trainable machine learning backend 112 aids in automatic label generation, using a neural network having trainable weights that are used to optimize one or more error terms periodically as touchpoints are labelled, and dependencies are resolved. The trainable machine learning backend 112 generates automatic labels which can also be used to establish default states based on high confidence classifications (e.g., classifications greater than a particular normalized logit value) for identified touchpoints, which may assist with reducing the review burden, especially for highly complex codebases.

In some embodiments, as additional estimated dependencies are verified and review outputs are generated, review tuples can be established to provide a dataset for training the machine learning model data architecture of trainable machine learning backend 112 that is trained for tracking dependency characteristics such that an overall accuracy of dependency estimation can be updated. For example, the system may generate an automatic estimated status indicator for a particular dependency, such as valid dependency, action required, further investigation required, or no valid dependency, and for lower confidence labels that have been generated, the system can be configured to provide, on a review interface, an investigation panel (which can be a code explorer) and a corresponding review input field, where the review user can provide a trustworthy input that is collated by a feedback system to generate training tuples for generating training datasets for retraining the model periodically to optimize for reducing a loss function representing an error term between the estimation and the code reviewer's input field, which is used as a “ground truth” signal. In some embodiments, for high confidence label generation, the system can be configured for autofill of a controllable user interface field such that the review user can more quickly focus attention on lower confidence labels. The training can be periodically triggered by the state machine 116 indicating that a particular intermediate data object is complete and ready for processing and then archiving/discarding. This can be triggered in conjunction with downstream data process triggering by pipeline trigger engine 114.

The system is operated by a user, through, for example, a user interface page rendered by user interface controller 110.

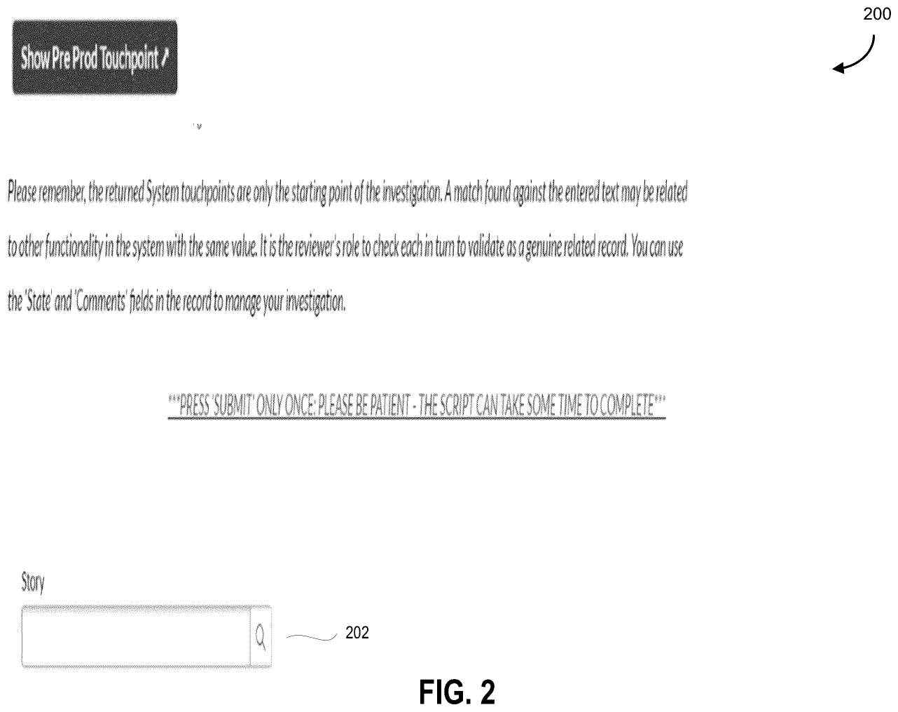

FIG. 2 shows an example UI page 200 including an interactive query entry input data object 202. On this UI page, a user with access can enter a line of text into 202 with which to analyse the system, reducing or eliminating other manual steps. The system outputs a system dependency record data object that is created which holds the information selected on the request page, along with the user details of the person who ran it and the type of request (Options are Data level, Field level and Table level requests). Attached to each systems dependency record data object, is a list of ‘system touchpoint’ record data objects, which are created when the parent System Dependency record is created. The systems dependency record data objects can be referred to directly in the saved software developer story fields to aid swift review and action by the developers. As this has been created as a custom application, it can be extracted and used in other instances of a development ticket tracking system, if required.

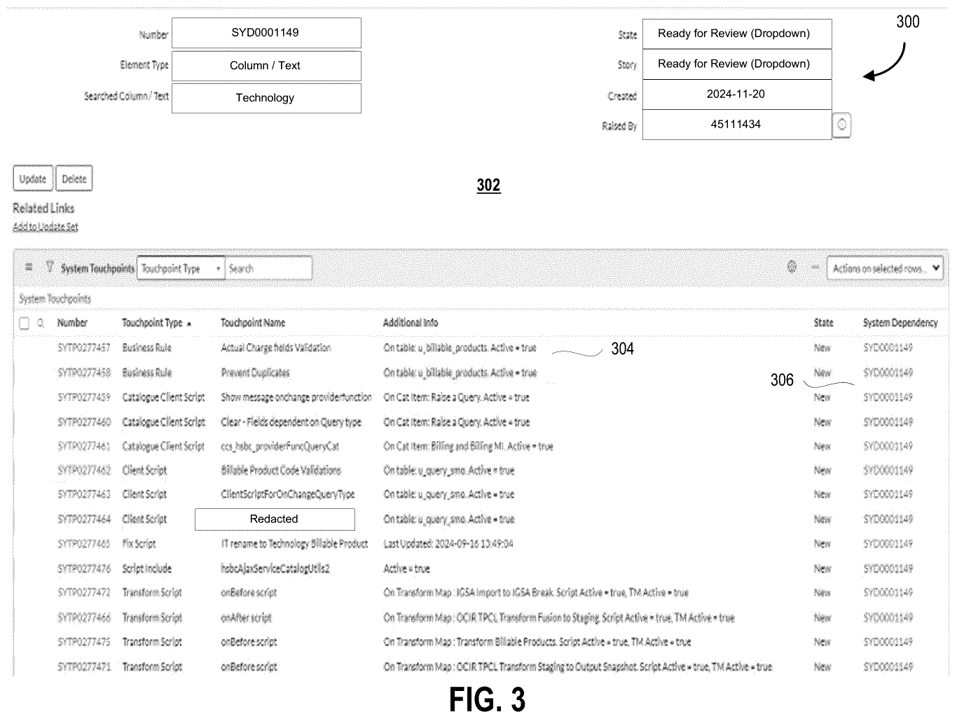

FIG. 3 shows an example UI page 300 including an example intermediate data object 302 showing a set of touchpoint record data objects 304 as visually represented. The touchpoint record data objects hold information about all the areas where a possible match has been found against the inputted text. The system touchpoint record data object can contain an accessible link 306 to the target record for easy access and investigation, plus additional fields for the state as tracked by the state machine 116 (new, complete), investigation result (dependency, no action required, further investigation required, no valid dependency). There can also a large text input field for comments which can further include commentary or explanations regarding an investigation result that is an additional field available on the intermediate data object 302 and usable by both as a record of explanation as well as an input into trainable machine learning backend 112. On the user interface provided by a user interface controller 110, there may also be a visual rendering of linked system touchpoints where a touchpoint element may have been called from another element in the system, showing one or more additional external relationships. This is useful to tie multiple dependencies together through tags. These can be stored as a list of metadata tags that, for example, can be an array within a field for a particular system touchpoint record data object.

A system touchpoint record data object is generated based on a targeted search of the codebase by scanner tool 106, and any other related data elements the system can interface with that meets a specific query criteria, such as a dependency name, a regular expression, a search formula (e.g., search string as modified by specific search operators) using the sub-query scripts generated by the sub-query generator 104. The specific code element is scanned by the system to conduct the searching, and relevant portions or snippets can be identified. Each system touchpoint record data object represents a candidate estimated dependency that needs to be investigated and/or otherwise resolved, and is tracked in the intermediate data object as managed by state machine 116.

Example code for generating a touchpoint is provided below:

Code Snippet 2:

function createTouchpoint (sysDep, touchpointtype, touchpointName, table, ref, relatedparent, additionalinfo) {

| \| | | |
|---|---|---|
| \| | var createRecord = new GlideRecord(′u_system_touchpoint′); | |
| \| | createRecord.initialize( ); | |
| \| | createRecord.u_system_depencency = sysDep; | |
| \| | createRecord.u_state = ′1′; | |
| \| | createRecord.u_reference = ref; | |
| \| | createRecord.u_touchpoint _sys_id = ref; | |
| \| | createRecord.u_additional_info = additionalinfo; | |
| \| | createRecord.u_table = table; | |
| \| | createRecord.u_touchpoint_type = touchpointType; | |
| \| | createRecord.u_touchpoint_name= touchpointName; | |
| \| | createRecord.u_related_touchpoint = relatedParent; | |
| \| | createRecord. insert( ); | |
| \| | | |
| \| | if (touchpointType == ′Script Include′} { | |
| \| | \| | |
| \| | \| | relatedParent = createRecord. sys_id; |
| \| | \| | relatedParentSource = createRecord.u_touchpoint_sys_id; |
| \| | \| | name = createRecord.u_touchpoint_name; |
| \| | \| | |
| \| | \| | checkAccessControl(name, relatedParent); |
| \| | \| | checkAccessControlRole(name, relatedParent); |
| \| | \| | checkApplicationMenu(name, relatedParent); |
| \| | \| | checkModule(name, relatedParent); |
| \| | \| | checkBusinessRule(name, relatedParent); |
| \| | \| | checkcatalogueClientScripts(name, relatedParent); |
| \| | \| | checkUIPolicy(name, relatedParent); |
| \| | \| | checkClientScript(name, relatedParent); |
| \| | \| | checkContextMenu(name, relatedParent); |
| \| | \| | checkRoleDictionaryEntry(name, relatedParent); |
| \| | \| | checkDynamicContent(name, relatedParent); |
| \| | \| | checkFixScript(name, relatedParent); |
| \| | \| | checkInboundEmailActions(name, relatedParent); |
| \| | \| | checkUIMacro(name, relatedParent); |
| \| | \| | checkMenuItem(name, relatedParent); |
| \| | \| | checkNavigationHandler(name, relatedParent); |

Dependencies need not only be identified in interface/library function calls, but an estimated dependency can also be identified in different related data fields, such as in-line comments, comment blocks, among others, and these can be identified in by the scanner tool 106, through specially configured scripts from the sub-query generator 104 that are tailored for each type of data element being scanned. For example, a developer may write additional development notes explaining the development story in a comment block, explaining that a particular legacy variable was swapped out for a modern variable that is passed through a computer process as arguments. While the process/function and arguments may not include the specific string, nonetheless, the process/function and arguments are flagged due to the candidate dependency appearing in related code comment blocks that are proximate to the function call.

A system scan is then conducted by scanner tool 106 using one or more specially configured search scripts based on the user's search criteria and identified search scope. The scan can include text-based searches, regular expression searches, operator searches, among others, and in some embodiments, the scan script is generated based on the query, and then executed against all identified data elements in the search scope. In a further embodiment, a snapshot of target data elements in the search scope is identified, retrieved, and saved into an intermediate repository, and a single script is executed across the entire snapshot. This intermediate repository approach can help increase script/search execution speeds, as opposed to accessing each element individually and executing the script individually. The script can be configured to generate a pinpoint anchor data object in a particular coordinate or position in the data element, the pinpoint anchor data object representing a line number, a field identifier, depending on the data element. During the generation of the pinpoint anchor data object, the snapshot of the proximate text or data can also be generated and stored on the corresponding record.

Elements in the system that can be reviewed for dependencies in the application can include: Reference Columns, List Column, Database Views, Reports, Logical Business Rules, Client Scripts, Catalogue Client Scripts, Widgets, Scheduled Script Execution, Script Actions, Workflows, Transform Scripts, Field Maps, UI Actions, UI Pages, Column Calculated Values/Reference Qualifiers, Dictionary Overrides, Processors, Variables. Scripts are scanned and investigated, and scripts can also include, plus following linked elements: Logical/Business Rules, Client Scripts, Catalogue Client Scripts, Widgets, Scheduled Script Execution, Script Action, Workflow, Transform Scripts, Field Maps, UI Actions, UI Pages, Column Calculated Values/Reference Qualifiers, Dictionary Overrides, Processors, Variables, among others.

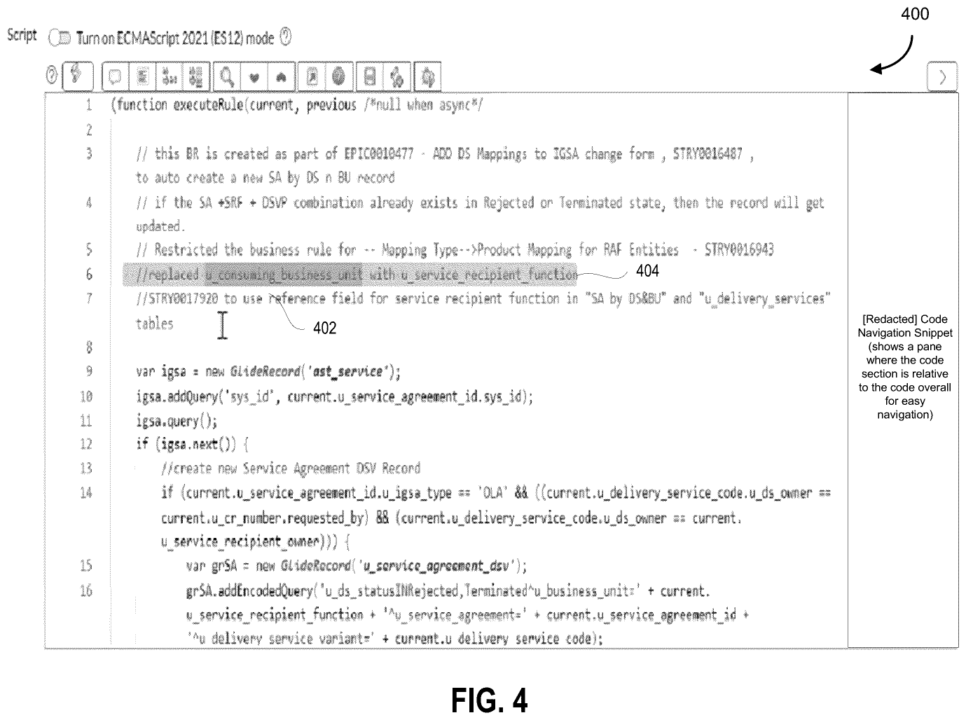

Once a scan is complete by scanner tool 106, an intermediate data object is generated representing all returned system touchpoints generated by candidate touchpoint generator engine 108. FIG. 4 shows an example UI page 400 showing an example code snippet that was first identified as having a match therein, and then an anchor point 402 is generated. The anchor point 404 crawled for information proximate thereof by the candidate touchpoint generator engine 108. This crawl can be conducted by storing into memory crawled string or character tokens until a delimiter character is reached such as a new paragraph or line carat object or a total number of characters or string tokens is reached. Identified anchor points (e.g., line 6, characters 10-19) matching the query are augmented and expanded by candidate touchpoint generator engine 108 to generate fulsome system touchpoint data objects including proximate snippets (e.g., +/−5 lines) and investigation links (<a href=http://example.com/#line6 #character10>, and instantiating fields for state transitions by the state machine 116. In some embodiments, the crawler process of the candidate touchpoint generator engine 108 is configured to crawl a number of lines or paragraphs up or down from the identified anchor point 402, and in some embodiments, a captive natural language engine is used to process the crawled information to generate a snippet. In another variation, the snippet is generated based on a recordation of the proximate data (e.g., +/−5 words).

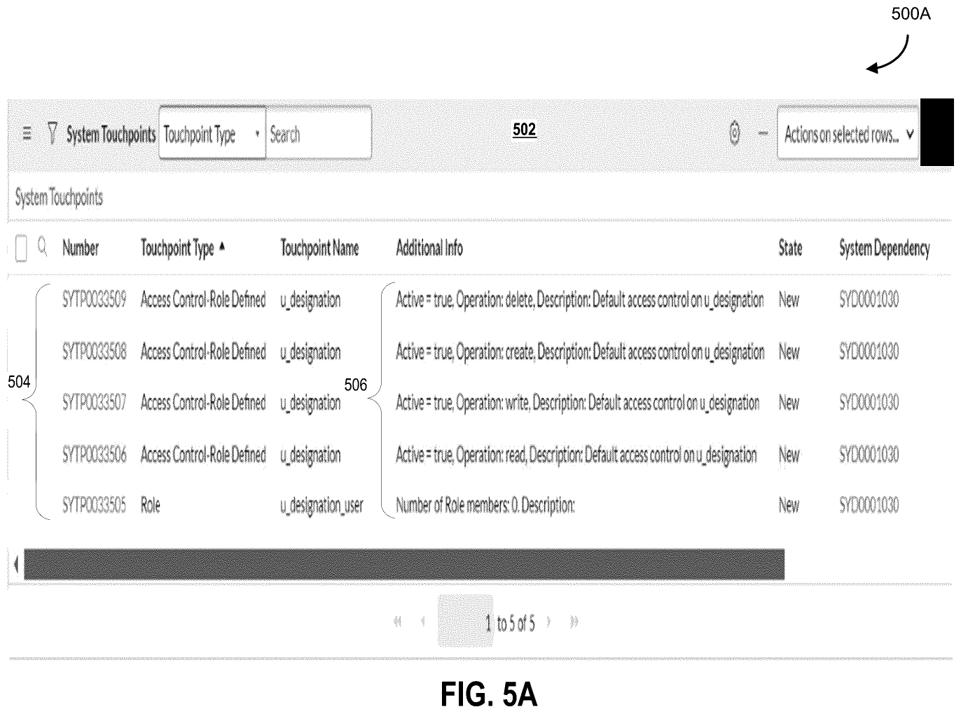

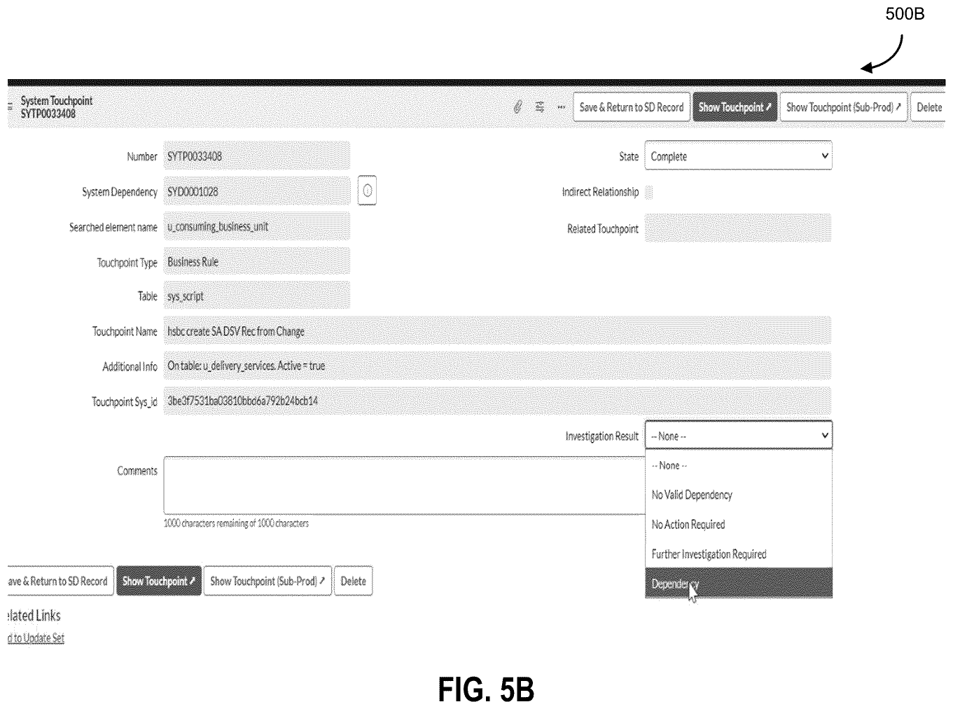

FIG. 5A shows an example UI page 500A including an example intermediate data object 502 showing a set of touchpoint record data objects 504 as visually represented alongside proximate snippets and investigation links. The touchpoint record data objects 504 may be prepopulated with state label estimations generated by the trainable machine learning backend 112, and the snippets are shown at 506.

FIG. 5B is an example UI page 500B where a reviewer/investigator user can modify a state using a visual interactive interface element, according to some embodiments.

The intermediate data object can be a relational database object, such as a database table, that has system touchpoints as individual rows, and fields corresponding to an automatically generated description of the touchpoint, a link to the repository pinpoint, the touchpoint type, an estimated label, a review status, and a resolution status. The individual system touchpoints can also be assigned for resolution by different user identifiers, such a repository owners, group owners, business function owners corresponding to the particular element being scanned. In some embodiments, the user identifier is obtained from an active directory repository 118.

The system touchpoints of the intermediate data object are only a starting point of a dependency investigation, as a match found against an entered text may be related to other functionality in a system with a same value, but not necessarily a genuine related dependency. The system is configured to generate a user interface dashboard for the user to conduct an investigation into each of the dependencies.

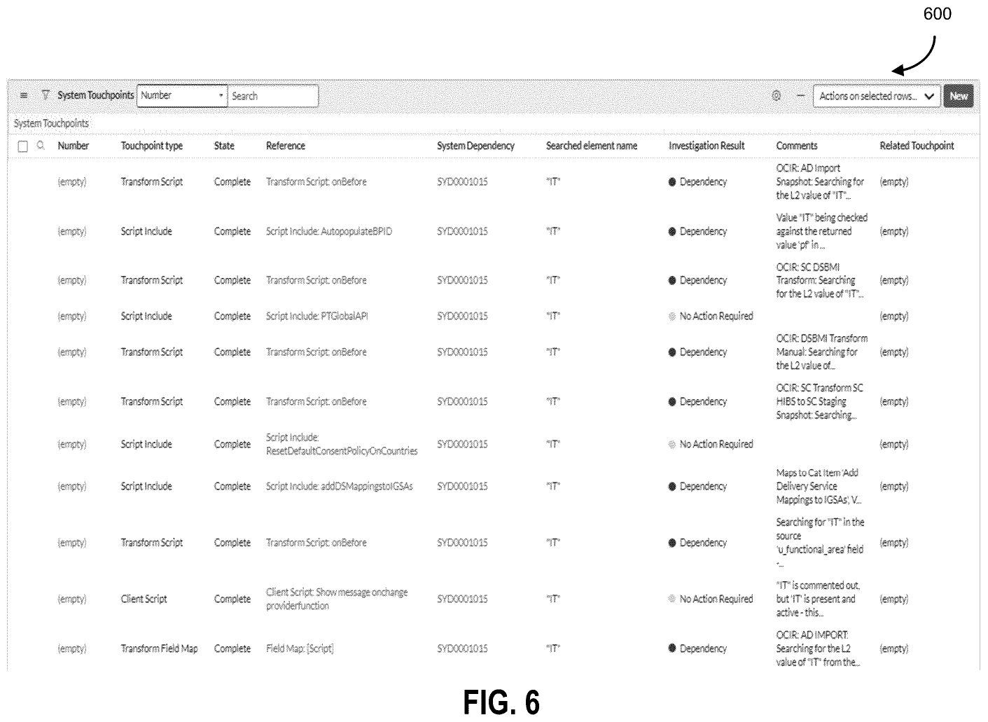

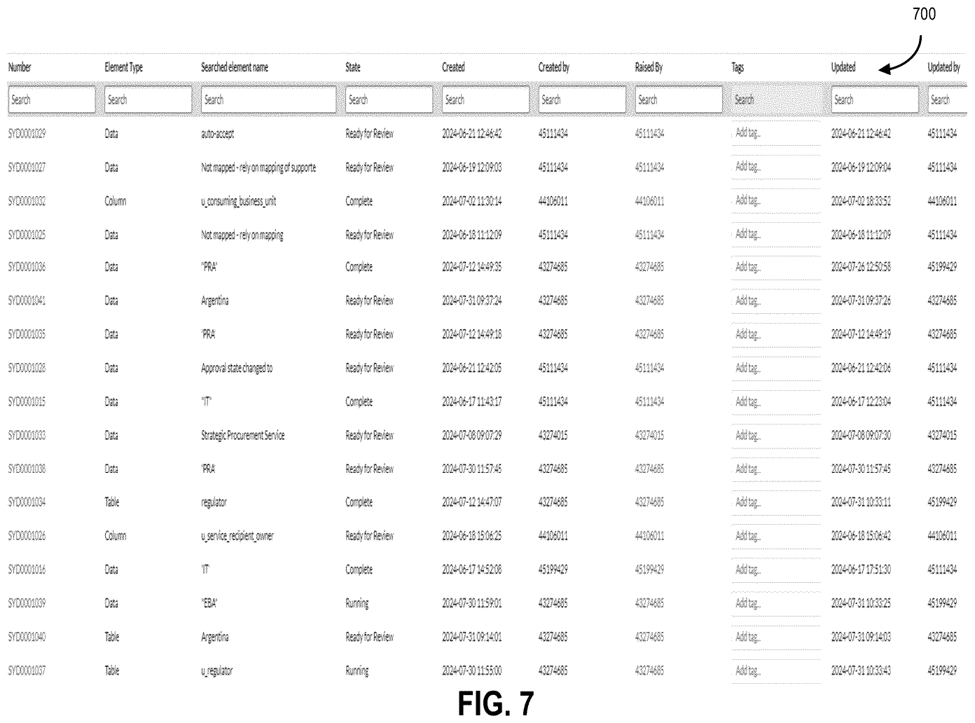

The repository pinpoint generated by candidate touchpoint generator engine 108 can be used as a starting point for a deep investigation, and when the user interacts with a visual rendered user interface element representing the repository pinpoint, an associated link to the codebase or repository can be automatically accessed, and in some embodiments, automatic traversal and/or visual effects, such as highlighting or snippet generation, can be applied directly in the investigation tool by the user interface controller 110, which can be a screen widget that is configured to take up a portion of the screen. There can be multiple views possible, such as a view generated with all open estimated touchpoints and unresolved dependencies for a particular project or search query, or a view generated for a particular user identifier showing all estimated touchpoints and unresolved dependencies assigned to that user. At FIG. 6, an example UI page 600 is shown where user tasks are identified based on a project view. At FIG. 7, an example UI page 700 is shown where user tasks are identified based on a user identifier view.

Every classification of an estimated touchpoint and every resolution of a potential dependency is recorded by updating the intermediate data object using state machine 116. In some embodiments, when a touchpoint is validated as a valid dependency, it is then utilized for a dependency resolution process flow, as transitioned through a state transition in the state machine 116. When all touchpoints are labelled, and all identified valid dependencies are resolved, the completed intermediate data object can then be archived and a project transition signal may be generated by the system, allowing a downstream data function to occur or be triggered by the pipeline trigger engine 114, such as initiating a systems update, committing code changes, modifying a library or a package, migrating an instance of a service from one hardware cluster to another, among others.

The completed intermediate data object can then be collated with other completed intermediate data objects for generating a feedback dataset for updating a machine learning classification engine maintained by trainable machine learning backend 112, such that for future dependency estimation tasks, the automatically generated label can have modified classifications based on an updated persisted machine learning model that has been trained using the feedback dataset. The features captured in the intermediate data object are useful in assisting the classification in adapting for variances in coding practices and conventions as between developers. For example, over time, the system can adapt to recognize that dependencies listed in code comment blocks are typically less indicative of a valid dependency, whereas dependencies listed in an in-line comment style block that is two lines proximate to an anchor point are typically more indicative of a valid dependency.

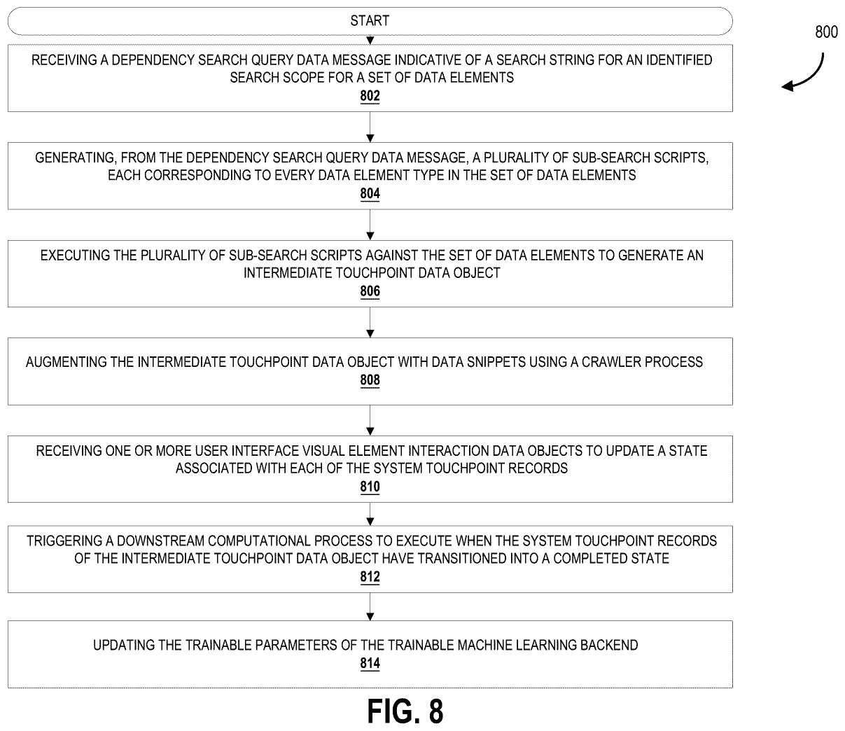

FIG. 8 show steps of an example computing method for automated software process dependency estimation, according to some embodiments. The method 800 is shown with example steps of a computing process that is executed by a coupled one or more computing processors that operate in conjunction with computer memory and data storage. The method 800 includes the steps of 802, receiving a dependency search query data message indicative of a search string for an identified search scope for a set of data elements; 804 generating, from the dependency search query data message, a plurality of sub-search scripts, each corresponding to every data element type in the set of data elements; 806 executing the plurality of sub-search scripts against the set of data elements to generate an intermediate touchpoint data object having one or more rows representing system touchpoint records each corresponding to an anchor position data object for each match to the sub-search scripts found in the set of data elements; 808 augmenting the intermediate touchpoint data object with data snippets using a crawler process configured to extract information proximate to coordinates of the anchor position data object; 810 receiving one or more user interface visual element interaction data objects to update a state associated with each of the system touchpoint records; and 812, triggering a downstream computational process to execute when the system touchpoint records of the intermediate touchpoint data object have transitioned into a completed state. In 814, a variation of process 800 is provided whereby the intermediate touchpoint data object, once completed, is converted into a snapshot data object and used for updating the trainable parameters of the trainable machine learning backend, which is configured for automatic state identification based on classification labels.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computer implemented system for automated software process dependency estimation, comprising one or more computing processors that operate in conjunction with computer memory and data storage, the one or more computing processors configured to:
receive a dependency search query data message indicative of a search string for an identified search scope for a set of data elements;
generate, from the dependency search query data message, a plurality of sub-search scripts, each corresponding to every data element type in the set of data elements;
execute the plurality of sub-search scripts against the set of data elements to generate an intermediate touchpoint data object having one or more rows representing system touchpoint records each corresponding to an anchor position data object for each match to the sub-search scripts found in the set of data elements;
augment the system touchpoint records of the intermediate touchpoint data object with data snippets using a crawler process configured to extract information proximate to coordinates of the anchor position data object;
receive one or more user interface visual element interaction data objects to update a state associated with each of the system touchpoint records; and
trigger a downstream computational process to execute when the system touchpoint records of the intermediate touchpoint data object have transitioned into a completed state.

2. The computer implemented system of claim 1, wherein the one or more computing processors are configured to convert the intermediate touchpoint data object, once completed, into a snapshot data object; and
update trainable parameters of the trainable machine learning backend, which is configured for automatic state identification based on classification labels that are used to pre-populate the state associated with each of the system touchpoint records using the data snippets.

3. The computer implemented system of claim 2, wherein the pre-populating of the state the associated with each of the system touchpoint records using the data snippets is conducted during the augmenting of the intermediate touchpoint data object.

4. The computer implemented system of claim 1, wherein the system touchpoint records, once generated, are assigned for resolution by individual system owner user identifiers as identified by an active directory repository managing user account relationships with the data element from which the corresponding system touchpoint record is generated from.

5. The computer implemented system of claim 1, wherein the downstream computational process that is executed includes a systems update or code modification corresponding to the dependency search query data message.

6. The computer implemented system of claim 5, wherein the systems update or code modification is executed against all data elements identified in the system touchpoint records.

7. The computer implemented system of claim 5, wherein the systems update or code modification is executed against only against all data elements identified in the system touchpoint records having a state indicative of a valid dependency.

8. The computer implemented system of claim 5, wherein following the systems update or the code modification all data elements identified in the system touchpoint records having a state indicative of a valid dependency are associated with a system mobility monitoring process.

9. The computer implemented system of claim 6, wherein the system mobility monitoring process is configured to automatically trigger a rollback of the systems update or the code modification upon determining that a computing process or a computing module failure has occurred at any of the data elements identified in the system touchpoint records.

10. The computer implemented system of claim 1, wherein the system is a special purpose computing appliance residing in a data center and coupled by a message bus to one or more codebase repositories, receiving as an input the dependency search query data message from the message bus, and generating the trigger signal to trigger the downstream computational process as an output on the message bus.

11. A computer implemented method for automated software process dependency estimation, the computer implemented method executable as a process that is executed by a coupled one or more computing processors that operate in conjunction with computer memory and data storage, the method comprising:
receiving a dependency search query data message indicative of a search string for an identified search scope for a set of data elements;
generating, from the dependency search query data message, a plurality of sub-search scripts, each corresponding to every data element type in the set of data elements;
executing the plurality of sub-search scripts against the set of data elements to generate an intermediate touchpoint data object having one or more rows representing system touchpoint records each corresponding to an anchor position data object for each match to the sub-search scripts found in the set of data elements;
augmenting the system touchpoint records of the intermediate touchpoint data object with data snippets using a crawler process configured to extract information proximate to coordinates of the anchor position data object;
receiving one or more user interface visual element interaction data objects to update a state associated with each of the system touchpoint records; and
triggering a downstream computational process to execute when the system touchpoint records of the intermediate touchpoint data object have transitioned into a completed state.

12. The computer implemented method of claim 11, further comprising converting the intermediate touchpoint data object, once completed, into a snapshot data object; and updating trainable parameters of the trainable machine learning backend, which is configured for automatic state identification based on classification labels that are used to pre-populate the state associated with each of the system touchpoint records using the data snippets.

13. The computer implemented method of claim 12, wherein the pre-populating of the state the associated with each of the system touchpoint records using the data snippets is conducted during the augmenting of the intermediate touchpoint data object.

14. The computer implemented method of claim 11, wherein the system touchpoint records, once generated, are assigned for resolution by individual system owner user identifiers as identified by an active directory repository managing user account relationships with the data element from which the corresponding system touchpoint record is generated from.

15. The computer implemented method of claim 11, wherein the downstream computational process that is executed includes a systems update or code modification corresponding to the dependency search query data message.

16. The computer implemented method of claim 15, wherein the systems update or code modification is executed against all data elements identified in the system touchpoint records.

17. The computer implemented method of claim 15, wherein the systems update or code modification is executed against only against all data elements identified in the system touchpoint records having a state indicative of a valid dependency.

18. The computer implemented method of claim 15, wherein following the systems update or the code modification all data elements identified in the system touchpoint records having a state indicative of a valid dependency are associated with a system mobility monitoring process.

19. The computer implemented method of claim 16, wherein the system mobility monitoring process is configured to automatically trigger a rollback of the systems update or the code modification upon determining that a computing process or a computing module failure has occurred at any of the data elements identified in the system touchpoint records.

20. A non-transitory computer readable medium storing machine interpretable instructions, which when executed by a processor, cause the processor to execute a computer implemented method for automated software process dependency estimation, the method comprising:
receiving a dependency search query data message indicative of a search string for an identified search scope for a set of data elements;
generating, from the dependency search query data message, a plurality of sub-search scripts, each corresponding to every data element type in the set of data elements;
executing the plurality of sub-search scripts against the set of data elements to generate an intermediate touchpoint data object having one or more rows representing system touchpoint records each corresponding to an anchor position data object for each match to the sub-search scripts found in the set of data elements;
augmenting the system touchpoint records of the intermediate touchpoint data object with data snippets using a crawler process configured to extract information proximate to coordinates of the anchor position data object;
receiving one or more user interface visual element interaction data objects to update a state associated with each of the system touchpoint records; and
triggering a downstream computational process to execute when the system touchpoint records of the intermediate touchpoint data object have transitioned into a completed state.
